(19) United States
(12) Patent Application Publication
(10) Pub. No.: US 2009/0240761 A1
(43) Pub. Date: Sep. 24, 2009

(54) Sending voluminous data over the internet

(76) Inventors: Nelson Nahum, Tustin, CA (US); Moshe Melnikov, Ramat (IL)

Correspondence Address: LSI Corporation c/o Suiter Swantz pc llo, 14301 FNB Parkway, Suite 220, Omaha, NE, 68154, US

(21) Appl. No.: 12/077,804

(22) Filed: Mar. 20, 2008

(51) Int. Cl. G06F 15/16

(52) U.S. Cl. 709/201

(57) ABSTRACT

A system comprises a first set of data transfer tools, operable by and exhibited to a first workstation and a second workstation, the first set of data transfer tools including commands for controlling transfer and communication, a second set of data transfer tools, operable by and exhibited to the first workstation and the second workstation, the second set of data transfer tools implementing and processing transfer and communication of data between workstations involved in a communication, and a remote storage device coupled to a communications network, accessible by the first workstation and the second workstation, for temporarily storing data communicated from one workstation to the second workstation.

### FIELD OF THE INVENTION

The present disclosure relates generally to data transfer and more particularly to a method and a system for transferring a large volume of data through the Internet.

### BACKGROUND

It is often useful to send large files over a communications and information network such as the Internet. Large files are for example: sets of pictures, video movies, music collection, commercial presentations, voluminous alphanumeric documents, medical information and the like.

It would thus be advantageous to provide a method and a system for transferring a large volume of data through a communications network.

### SUMMARY OF THE INVENTION

A computationally implemented system includes, but is not limited to: a first set of data transfer tools, operable by and exhibited to a first workstation and a second workstation, the first set of data transfer tools including commands for controlling transfer and communication, a second set of data transfer tools, operable by and exhibited to the first workstation and the second workstation, the second set of data transfer tools implementing and processing transfer and communication of data between workstations involved in the communication, and a remote storage device coupled to a communications network, accessible by the first workstation and the second workstation, for temporarily storing data communicated from one workstation to the second workstation. In addition to the foregoing, other computationally implemented method aspects are described in the claims, drawings, and text forming a part of the present disclosure.

A computationally implemented method includes, but is not limited to: providing a first set of data transfer tools, operable by and exhibited to a first workstation and a second workstation, the first set of data transfer tools including commands for controlling transfer and communication among the first workstation and the second workstation; providing a second set of data transfer tools, operable by and exhibited to the first workstation and the second workstation, the second set of data transfer tools implementing and processing transfer and communication of data between the first workstation and the second workstation; providing a remote storage device coupled to the communications network, accessible by the first workstation and the second workstation, for temporarily storing data communicated from one workstation to the second workstation; and communicating the data from the first workstation through the remote storage device to the second workstation. In addition to the foregoing, other computationally implemented method aspects are described in the claims, drawings, and text forming a part of the present disclosure.

A computationally implemented system includes but is not limited to: means for providing a first set of data transfer tools, operable by and exhibited to both a first workstation and a second workstation as a virtual removable external storage device, the first set of data transfer tools including commands for controlling transfer and communication among the first workstation and the second workstation; means for providing a second set of data transfer tools, operable by both the first workstation and the second workstation, the second set of data transfer tools implementing and processing transfer and communication of data between the first workstation and the second workstation; means for providing a remote storage device coupled to the communications network, accessible by the first workstation and the second workstation, for temporarily storing data communicated from one workstation to the second workstation; and means for communicating the data from the first workstation through the remote storage device to the second workstation. In addition to the foregoing, other computationally implemented method aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The numerous advantages of the present invention may be better understood by those skilled in the art by reference to the accompanying figures in which:

FIG. 1 is a schematic diagram illustrating a system according to an exemplary embodiment of the invention;

FIG. 2A is a schematic diagram illustrating a system according to an exemplary embodiment of the invention;

FIG. 2B is a detailed schematic diagram illustrating a system according to an exemplary embodiment of the invention;

FIG. 3 is a schematic diagram illustrating a system according to an exemplary embodiment of the invention;

FIG. 4 illustrates an operational flow representing example operations related to providing a method for transferring voluminous data over a communications network;

FIG. 5 illustrates an alternative embodiment of the operational flow of FIG. 4; and

FIG. 6 illustrates an alternative embodiment of the operational flow of FIG. 4.

### DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

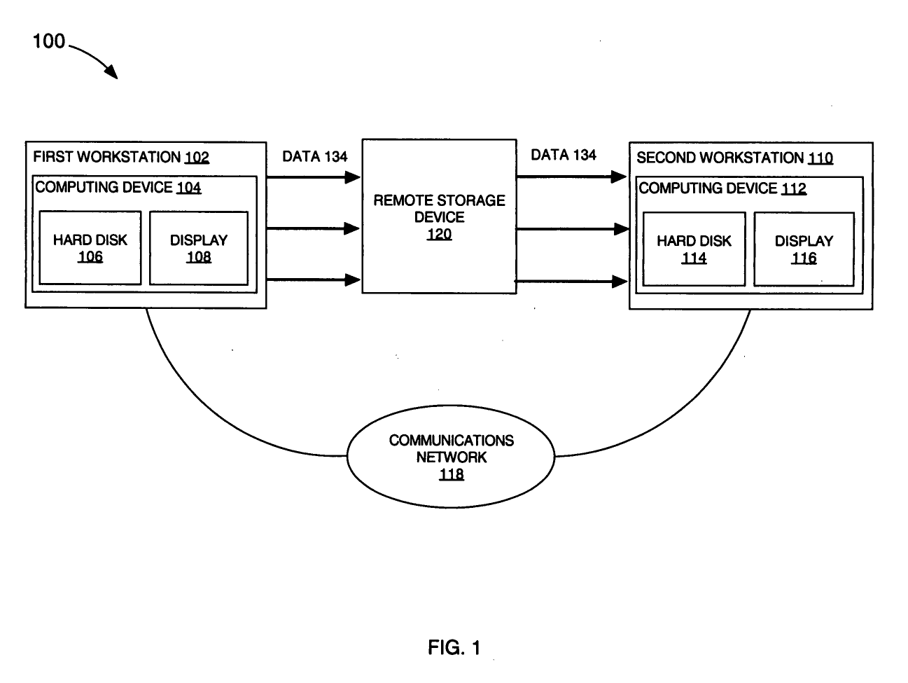

Referring to FIG. 1 a schematic diagram illustrating a system 100 according to an exemplary embodiment of the invention is shown. The first workstation 102 may comprise a first workstation computing device 104 (e.g. a computer, handheld device, etc.), further including at least one hard disk 106 and at least one display 108. The first workstation computing device 104 may be any device capable of processing one or more programming instructions. For example, the computing device 104 may be a desktop computer, a laptop computer, a notebook computer, a mobile phone, a personal digital assistant (PDA), combinations thereof, and/or other suitable computing devices. The computing device 104 may also include at least a portion of one or more peripheral devices connected/connectable (e.g., via wired, waveguide, or wireless connections). Peripheral devices may include one or more printers, one or more fax machines, one or more peripheral memory devices (e.g., flash drive, memory stick), one or more network adapters (e.g., wired or wireless network adapters), one or more music players, one or more cellular telephones, and the like). A first workstation 102 operator or a first workstation 102 may be desirous of sending a voluminous amount of data to a second workstation 110 via a communications network 118.

The second workstation 110 may comprise a second workstation computing device 112, further including a second hard disk 114 and a second display 116. The second workstation computing device 112 may be any device capable of processing one or more programming instructions. For example, the computing device 112 may be a desktop computer, a laptop computer, a notebook computer, a mobile phone, a personal digital assistant (PDA), combinations thereof, and/or other suitable computing devices. The computing device 112 may also include at least a portion of one or more peripheral devices connected/connectable (e.g., via wired, waveguide, or wireless connections). Peripheral devices may include one or more printers, one or more fax machines, one or more peripheral memory devices (e.g., flash drive, memory stick), one or more network adapters (e.g., wired or wireless network adapters), one or more music players, one or more cellular telephones, and the like). A first workstation 102 operator or a first workstation 102 may be desirous of sending a voluminous amount of data to a second workstation 110 via a communications network 118.

The first workstation 102 and/or the second workstation 110, or any component of the first workstation 102 and/or the second workstation 110 may be connected/connectable (e.g., via wired, waveguide, or wireless connections) to a communications network 118 such as the internet. Network connection may be made via any digital and/or an analog communication medium (e.g., a fiber optic cable, a waveguide, a wired communications link, a wireless communication link, etc.). In one embodiment, the first workstation 102 may be single data sender and the second workstation 110 may include one or more data recipients. However, in further embodiments, first and second workstation 102, 110 may include any number of data senders and recipients. It is further contemplated any of plurality of second workstations 110 may become a sender of data 134 to one or more (e.g. third workstation, fourth workstation) configured to be recipients of data, and the first workstation may be configured to receive data from at least one of the second workstation or external data source (e.g. a data source located in a location geographically distinct from the first workstation).

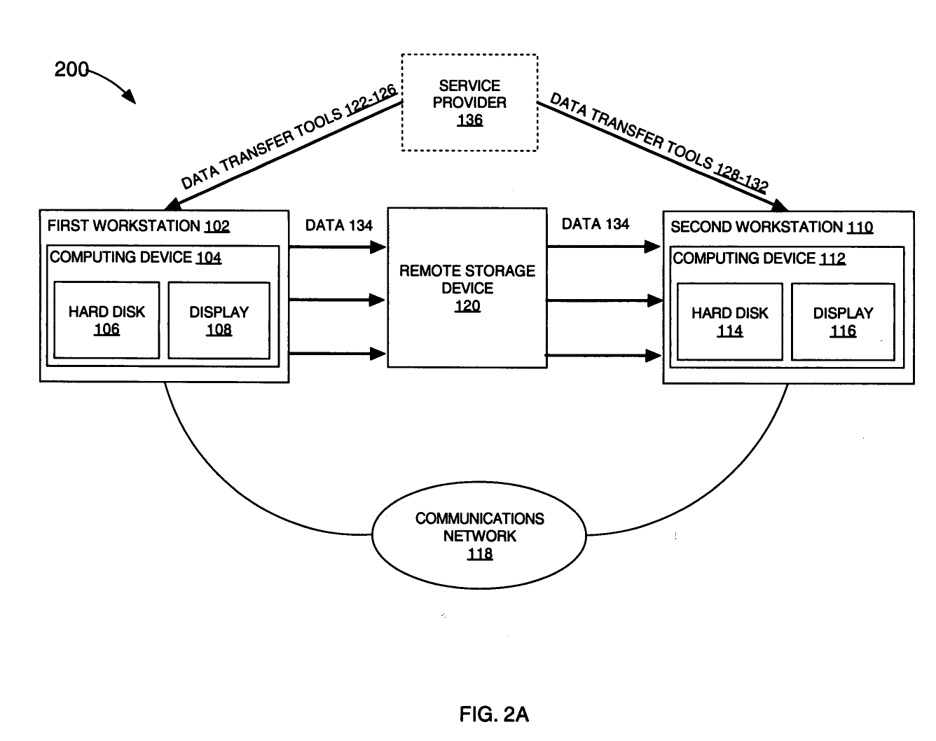

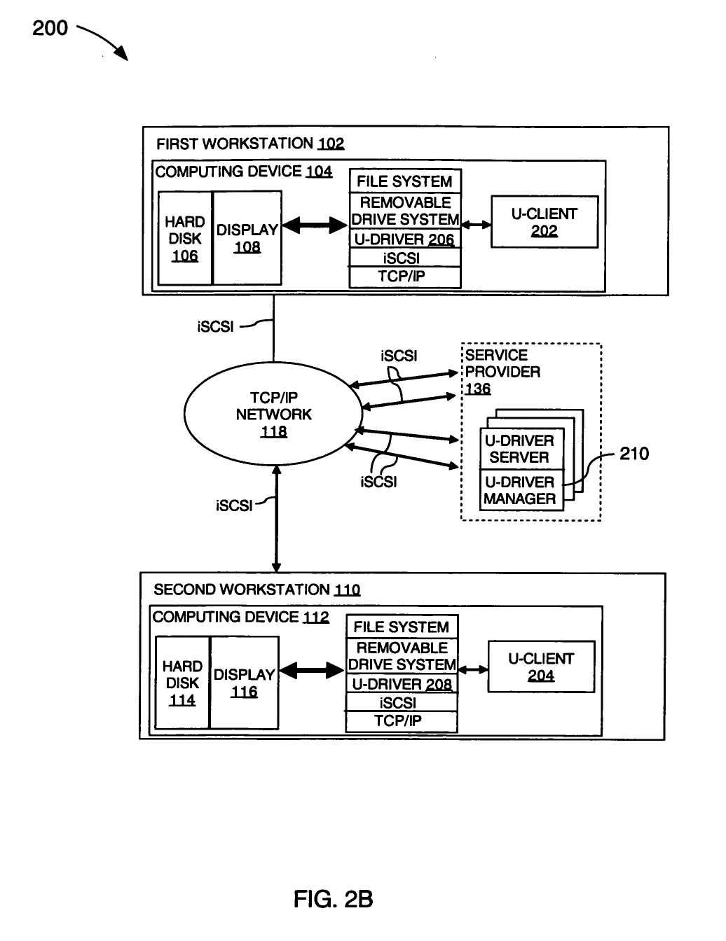

Referring to FIGS. 2A and 2B, additional schematic diagrams of a system 200 for transferring voluminous data is shown. The transfer of data between first and second workstation 102, 110 may be performed by an intermediary of a service provider 136. Intermediary may deliver any necessary data transfer tools 122-132 (FIG. 2A), such as, but not limited to, software computer application programs, data storage space, etc., to the first and second workstation 102, 110.

As noted above, data transfer tools 122-132 may be software computer application programs. In the preferred embodiment, system 100 comprises a first dedicated computer software program, operable by and exhibited to the first workstation 102 and the second workstation 110 and including commands for controlling transfer and communication, and a second dedicated computer software program, operable by and exhibited to the first workstation 102 and the second workstation 110, implementing and processing transfer and communication of data between workstations involved in the communication In one instance, software computer application programs may include a u-client 202, 204 and a u-driver 206, 208 that may be downloaded from a communications network 118 (TCP/IP network in FIG. 2B), or provided to a workstation 102, 110 by any other means. The u-client 202, 204 may open a command window on the display of the workstation and exhibit an array of commands applicable to execute the transfer of data. U-driver 206, 208 may communicate data to a remote virtual removable storage device 120, for instance, over a communications network 118 such as the Internet. The u-driver 206, 208 may be provided instructions for the communication of data by, for example, the operation of an iSCSI protocol application iAP for the encapsulation of the SCSI commands. Any protocol permitting the first workstation 102 to send an SCSI command to an SCSI storage device 120 on a remote server may be utilized. Data may be packaged into TCP/IP packets that enable input-output (I/O) block-data transport over IP networks. In turn, the iSCSI protocol permits transmission of the data over a communications network 118 to a storage destination address, thus to a remote disk, which is managed by a u-driver manager 210 supported and operated by the service provider 136. The u-driver 206, 208 may operate an SCSI command. The SCSI command may transfer the data 134 (FIG. 2A) as blocks.

For data storage and transfer purposes, the first workstation 102 receives an internet address of a remote storage device 120 from the service provider. In this manner, the service provider temporarily leases the use of the remote storage device 120 to the first workstation 102. First workstation 102 may provide the e-mail address of the remote storage device 120 to the second workstation 110, permitting the second workstation 110 to access to the remote storage device 120 and retrieve data transmitted from the first workstation 102 to the remote storage device 120.

The u-driver may appear as an on-display emulation of a removable external memory drive. The emulated removable external memory drive may be selectable as desired, as either as a removable flash memory, a removable disk drive, and/or as any other type of removable external memory. For example, external memory drive may be selectable as aUSB emulation such as a Disk-on-Key®.

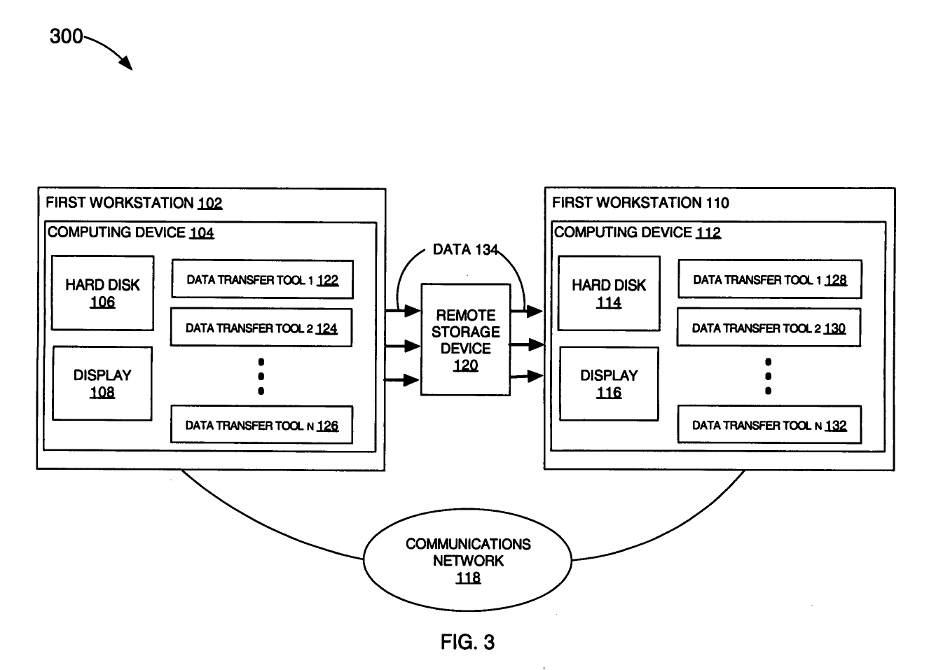

Referring to FIG. 3, an additional detailed schematic diagram of a system 100 for transferring voluminous data according to an exemplary embodiment of the present invention is shown. The first workstation 102 may transfer data 134 to a remote storage device 120 via the communications network 118. Remote storage device 120 may be located in a location geographically distinct from the location of the first workstation 102 and/or the second workstation 110. Following receipt of data transfer tools 122-132 from the service provider 136, first workstation 102 may include a plurality of data transfer tools 122-126 and second workstation 110 may include a plurality of data transfer tools 128-132. The first workstation data transfer tools 122-126 and the second workstation data transfer tools 128-132 may be substantially similar computing implemented programs or software. As noted above, the first workstation 102 may transfer data to a remote storage facility via the internet. Plurality of data transfer tools 122-126 may be configured to facilitate the transfer of voluminous data 134 from a first workstation 102 to a remote storage device 120. The second workstation 110 may be permitted to retrieve the data 134 from the remote storage device 120, and the plurality of data transfer tools 128-132 may be configured to facilitate retrieval of voluminous data 134 from the remote storage device 120. Storage device 120 may be leased for the amount of time required by the data transfer, or for any amount of time desired by an operator or necessary to complete any number of data transfer operations.

To begin a data transfer, the first workstation 102 may utilize a data transfer tool 122 from the plurality of first data transfer tools 122-126 to format the data 134. The data transfer tool 122 may be configured to receive and respond to known commands familiar to personal and/or professional computing device users. For example, the data transfer tool 122 may include commands for retrieving data from a hard disk 106 and for copying data 134 to any another memory device. With the assistance of the data transfer tool 122, the first workstation 102 may transmit the data 134 to a remote storage device 120 to be stored. Remote storage device 120 may be temporarily leased from a service provider. The second workstation 110 may be permitted access to the remote storage device 120, and with a data transfer tool 128 from the plurality of second data transfer tools 128-132, the second workstation 110 may retrieve the data 134. The process of communicating data 134 from the first workstation 102 to the second workstation 110 is thereby completed.

Data transfer may require the purchase of one of a plurality of services from the service provider 136, such as, the temporary lease of storage space, and a connection to the remote storage device 120 may be terminated.

The first workstation 102 may install the u-client and the u-driver software application programs on the first workstation 102 computing device. These application programs may be downloaded from a communications network 118, for example. Subsequently, the second workstation 110 acquires the internet address of a remote storage device 120 from the service provider 136.

The first workstation 102 may activate the u-client, which, when operative, is presented to a user via the first workstation 102 display. In one embodiment, u-client may appear on the first workstation 102 display as a command window. The first workstation 102 may be permitted to “mount”, or more “virtually mount” a virtual external removable storage device 120 (VEX) for short by utilizing one of the commands of the command window (e.g. a “mount command”). The virtual mounting of a VEX by the first workstation 102 may be equivalent to a perceived response from the first workstation 102 computing device when manually coupling thereto a real external removable storage device 120.

In practice, the u-driver emulates a virtual external storage device (VEX) on the first workstation 102 display. VEX may operate and respond as a real external memory device. The first workstation 102 may then retrieve the data to be communicated, either from the first workstation 102 hard disk, and/or from any other memory device coupled to the first workstation 102 computing device, and/or by copying or by dragging the data to the VEX as displayed.

Post transmission to a remote storage device 120 and storage of the data on the remote disk, the first workstation 102 may select the command to “dismount” the VEX from the u-client command window. The demounting of the first workstation 102 may be equivalent or substantially equivalent to the physical disconnection of a real external removable storage device from the first workstation 102 computing device.

The first workstation 102 operates the u-client command window and selects a command ordering, for instance, “send VEX to e-mail address mmm·nnn.com of remote workstation 110”, and “notify second workstation 110.” It is contemplated that the first workstation 102 may be required to indicate both the IP address of the remote storage device 120 as received from the service provider 136, and the e-mail address of the second workstation 110. Thus, the first workstation 102 may execute a request to the service provider 136 to send an e-mail message to the address(es) of the second workstation 110, announcing that data was sent for retrieval by the second workstation 110 at the storage destination address of the remote disk.

In parallel, the service provider 136 may transmit an e-mail message to the e-mail address of the second workstation 110 after the service provider 136 has been provided the second workstation 110 e-mail address. The remote storage device 120 may not store an email address for the second workstation 110. The remote storage device 120 may include an IP address that may be automatically retrieved when the second workstation 110 loads the u-drive client software. For instance, the u-drive client may communicate with the service provider 136 and the service provider 136 may communicate to the u-drive the service provider 136 has a U-drive at the IP address. The service provider 136 may have the e-mail address of the second workstation 110 and a queued incoming message. The incoming message may include an indication links to the software application computer programs, namely the u-driver and the u-client, and the e-mail address of the remote storage device 120 containing the data are attached.

After receiving the e-mail message from the service provider 136, the second workstation 110 retrieves the u-driver and the u-client facilities, as well as the address of the remote storage device 120 containing the data.

In turn, the second the second workstation 110 installs the u-client and the u-driver on the second workstation 110 computing device. In one embodiment, the u-client and the u-driver may be installed either by downloading the necessary program or programs from a communications network 118, obtaining a hard copy of the necessary program or programs, or by other means. It is noted that the second workstation 110 may include more than one data recipients, therefore involving more than one workstation computing device.

The second workstation 110 may utilize a second workstation 110 command window to select an access command to access the available remote storage device 120. Second workstation 110 may then select a “mount VEX” command, which permits the second workstation 110 to retrieve the data by copying or dragging the data stored in the VEX to the second workstation 110 hard disk or to any other memory device operative with the second workstation 110 computing device.

Finally, after a data transfer, the first workstation 102 may terminate the lease of the remote storage device 120.

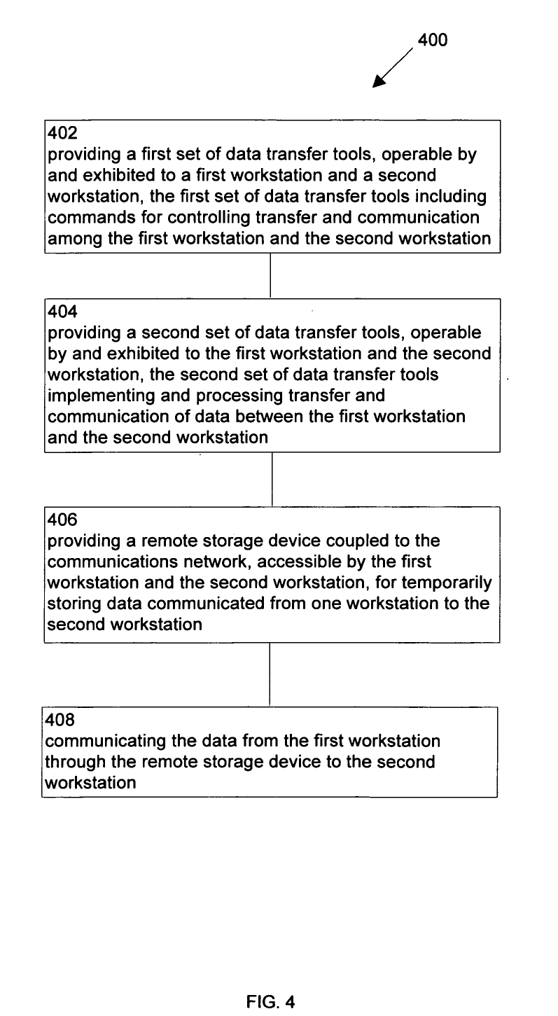

FIG. 4 illustrates an operational flow 400 representing example operations related to FIGS. 1-3. In FIG. 4 and in following figures that include various examples of operational flows, discussion and explanation may be provided with respect to the above-described examples of FIGS. 1-3 and/or with respect to other examples and contexts. However, it should be understood that the operational flows may be executed in a number of other environments and contexts, and/or in modified versions of FIGS. 1-3. Also, although the various operational flows are presented in the sequence(s) illustrated, it should be understood that the various operations may be performed in other orders than those which are illustrated, or may be performed concurrently.

Method 400 begins at an operation 402. Operation 402 depicts providing a first set of data transfer tools, operable by and exhibited to a first workstation and a second workstation, the first set of data transfer tools including commands for controlling transfer and communication among the first workstation and the second workstation. Operation 404 depicts providing a second set of data transfer tools, operable by and exhibited to the first workstation and the second workstation, the second set of data transfer tools implementing and processing transfer and communication of data between the first workstation and the second workstation. Operation 406 depicts providing a remote storage device coupled to the communications network, accessible by the first workstation and the second workstation, for temporarily storing data communicated from one workstation to the second workstation. Operation 408 depicts communicating the data from the first workstation through the remote storage device to the second workstation.

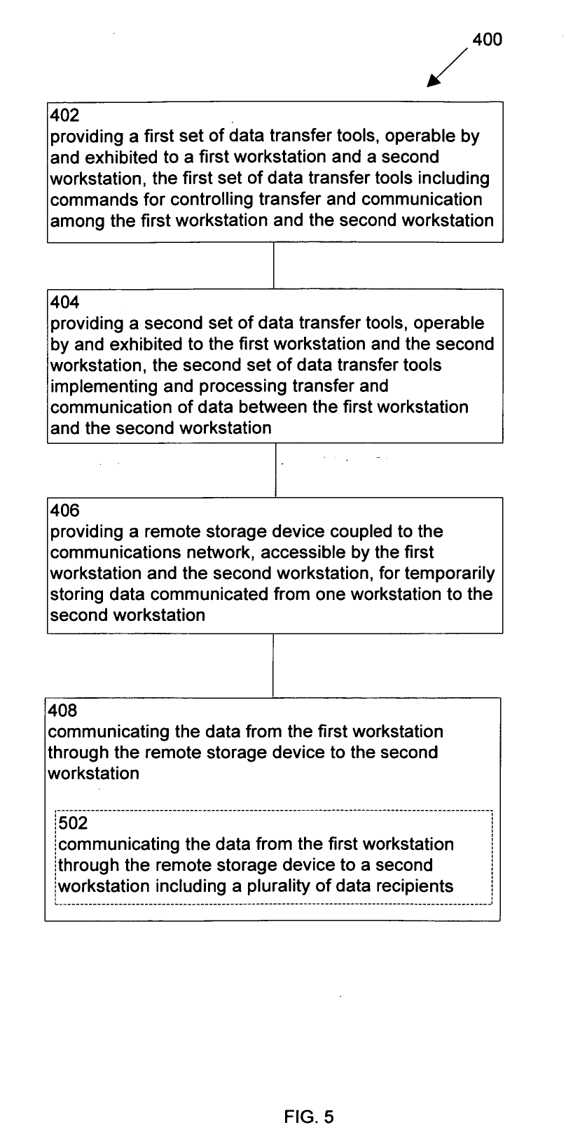

FIG. 5 illustrates alternative embodiments of the example operational flow 400 of FIG. 4. FIG. 5 illustrates example embodiments where the operation 408 may include at least one additional operation. Additional operations may include an operation 502. The operation 502 depicts communicating the data from the first workstation through the remote storage device to a second workstation including a plurality of data recipients.

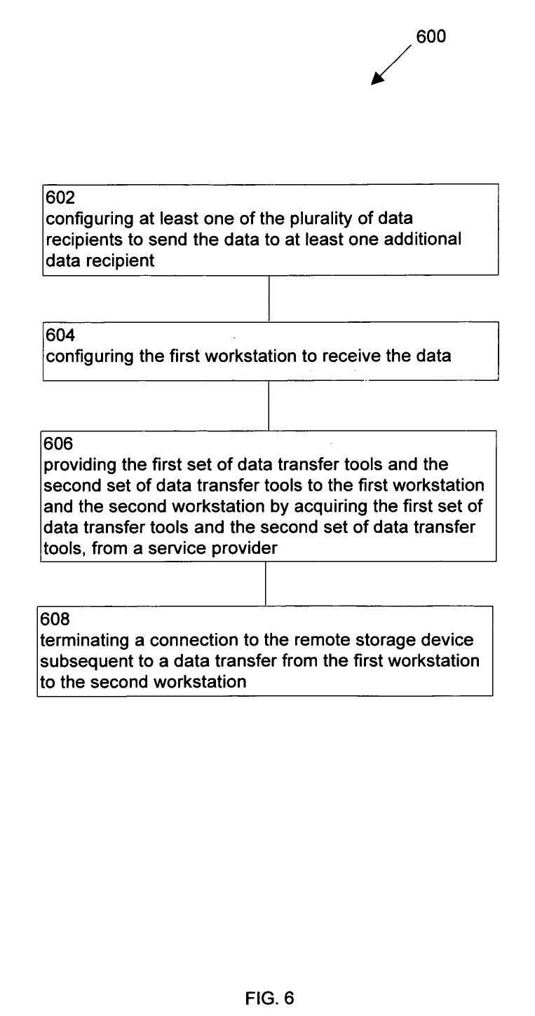

FIG. 6 illustrates alternative embodiments of the example operational flow 400 of FIG. 4. FIG. 6 illustrates example embodiments including at least one additional operation. Additional operations may include an operation 602, 604, 606 608, and/or 610. Operation 602 depicts configuring at least one of the plurality of data recipients to send the data to at least one additional data recipient. Operation 604 depicts configuring the first workstation to receive the data. Operation 606 depicts providing the first set of data transfer tools and the second set of data transfer tools to the first workstation and the second workstation by acquiring the first set of data transfer tools and the second set of data transfer tools, from a service provider. Operation 608 depicts providing remote storage device information to the first workstation and the second workstation by acquiring remote storage device information from a service provider and transferring the remote storage device information to the first workstation and the second workstation. Operation 610 depicts terminating a connection to the remote storage device subsequent to a data transfer from the first workstation to the second workstation. Any of operations 402-610 may be accomplished via the system 100 described in FIGS. 1-3 above.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed:

1. A system comprising:
a first set of data transfer tools, operable by and exhibited to a first workstation and a second workstation, the first set of data transfer tools including commands for controlling transfer and communication of data,
a second set of data transfer tools, operable by the first workstation and the second workstation, the second set of data transfer tools implementing and processing transfer and communication of data between the first and second workstations involved in a communication, and
a remote storage device coupled to a communications network, accessible by the first workstation and the second workstation, for temporarily storing data communicated from one workstation to the second workstation.

2. The system according to claim 1, wherein the second workstation includes a plurality of data recipients.

3. The system according to claim 2, wherein at least one of the plurality of data recipients is configured to send data to at least one additional data recipient.

4. The system according to claim 2, wherein the first workstation is configured to receive data from at least one of the second workstation or external data source.

5. The system according to claim 1, wherein the first set of data transfer tools, the second set of data transfer tools, are received by the first workstation and the second workstation from a service provider.

6. The system according to claim 1, wherein the remote storage device is made accessible to the first workstation and the second workstation by the first workstation and the second workstation acquiring remote storage device information from a service provider and transferring acquired remote storage device information to the first workstation and the second workstation.

7. A method comprising:
providing a first set of data transfer tools, operable by and exhibited to a first workstation and a second workstation, the first set of data transfer tools including commands for controlling transfer and communication among the first workstation and the second workstation;
providing a second set of data transfer tools, operable by and exhibited to the first workstation and the second workstation, the second set of data transfer tools implementing and processing transfer and communication of data between the first workstation and the second workstation;
providing a remote storage device coupled to the communications network, accessible by the first workstation and the second workstation, for temporarily storing data communicated from one workstation to the second workstation; and
communicating the data from the first workstation through the remote storage device to the second workstation.

8. The method according to claim 7, wherein the communicating the data from the first workstation through the remote storage device to the second workstation comprises:
communicating the data from the first workstation through the remote storage device to a second workstation including a plurality of data recipients.

9. The method according to claim 8, further comprising:
configuring at least one of the plurality of data recipients to send the data to at least one additional data recipient.

10. The method according to claim 7, further comprising:
configuring the first workstation to receive the data.

11. The method according to claim 7, further comprising:
providing the first set of data transfer tools and the second set of data transfer tools to the first workstation and the second workstation by:
acquiring the first set of data transfer tools and the second set of data transfer tools from a service provider; and
transferring the first set of data transfer tools and the second set of data transfer tools from the service provider to the first workstation and the second workstation.

12. The method according to claim 7, further comprising:
providing remote storage device information to the first workstation and the second workstation by acquiring remote storage device information from a service provider and transferring the remote storage device information to the first workstation and the second workstation.

13. The method according to claim 7, further comprising:
terminating a connection to the remote storage device subsequent to a data transfer from the first workstation to the second workstation.

14. A system comprising:
means for providing a first set of data transfer tools, operable by and exhibited to a first workstation and a second workstation as a virtual removable external storage device, the first set of data transfer tools including commands for controlling transfer and communication among the first workstation and the second workstation;
means for providing a second set of data transfer tools, operable by and exhibited to the first workstation and the second workstation, the second set of data transfer tools implementing and processing transfer and communication of data between the first workstation and the second workstation;
means for providing a remote storage device coupled to the communications network, accessible by the first workstation and the second workstation, for temporarily storing data communicated from one workstation to the second workstation; and
means for communicating the data from the first workstation through the remote storage device to the second workstation.

15. The system according to claim 14, wherein the communicating the data from the first workstation through the remote storage device to the second workstation comprises
means for communicating the data from the first workstation through the remote storage device to a second workstation including a plurality of data recipients.

16. The system according to claim 14, further comprising:
means for configuring at least one of the plurality of data recipients to send the data to at least one additional data recipient.

17. The system according to claim 14, further comprising:
means for configuring the first workstation may receive the data.

18. The system according to claim 14, further comprising:
means for providing the first set of data transfer tools and the second set of data transfer tools to the first workstation and the second workstation by acquiring the first set of data transfer tools, the second set of data transfer tools, and the remote storage device from a service provider.

19. The system according to claim 14, further comprising:
means for providing remote storage device information to the first workstation and the second workstation by acquiring remote storage device information from a service provider and transferring the remote storage device information to the first workstation and the second workstation.

20. The system according to claim 14, further comprising:
means for terminating a connection to the remote storage device subsequent to a data
transfer from the first workstation to the second workstation.
